(19) United States
(12) Patent Application Publication
(10) Pub. No.: US 2010/0232003 A1
(43) Pub. Date: Sep. 16, 2010

(54) VISION ENHANCING OPTICAL ARTICLES

(75) Inventors: Christopher J. Baldy, Murrysville, PA (US); Vitawat Lahsangah, Saint Petersburg, FL (US); Grady M. Lenski, Tampa, FL (US); Joseph D. Turpen, Safety Harbor, FL (US)

Correspondence Address: PPG INDUSTRIES INC;INTELLECTUAL PROPERTY DEPT, ONE PPG PLACE, PITTSBURGH, PA, 15272, US

(73) Assignee: TRANSITIONS OPTICAL, INC., Pinellas Park, FL (US)

(21) Appl. No.: 12/721,850

(22) Filed: Mar. 11, 2010

Related U.S. Application Data
(60) Provisional application No. 61/160,062, filed on Mar. 13, 2009.

(51) Int. Cl. G02B 5/23; G02B 1/00; G02B 1/04

(52) U.S. Cl. 359/243; 252/586

(57) ABSTRACT

The invention provides an optical article including a substrate; and a colorant composition connected to at least a portion of the substrate. The colorant composition is a fixed-tint colorant; and a photochromic material. The article exhibits a passive state and an activated state, such that the article can switch from the passive state to the activated state in response to at least actinic radiation and to revert back to the passive state in response to thermal energy. The passive state is characterized by a transmittance ranging from greater than 30% to 70% across a wavelength range of from 460 nanometers to 500 nanometers.

### CROSS-REFERENCE TO RELATED APPLICATIONS

This application claims the benefit of priority from U.S. Provisional Application No. 61/160,062, filed Mar. 13, 2009, which is incorporated by reference herein in its entirety.

### FIELD OF THE INVENTION

This invention relates to an optical article exhibiting one color in a passive state capable of switching to a second color in an activated state in response to at least actinic radiation.

### BACKGROUND OF THE INVENTION

Lenses having correct color for proper contrast and adequate level of darkening in high illumination conditions are particularly important for outdoor sports. The level of contrast and how this contrast is achieved is critical for optimal visual performance and for wearer comfort. Color perception is altered by the lighting conditions, the reflected color from a given colored object and from its surrounding environment, and any color filtering transparent material in the light path. Through the proper selection of eye wear containing both fixed tints and photochromic materials, the color and the darkness can be tuned to change with the dynamic irradiance of the sun to provide a consistent proper color and darkness level for optimum visual enhancing performance at each level of illumination.

Vision, of course, is about how we process light to create the images we see. All light, including outdoor sunlight, is composed of a variety of electromagnetic rays of different colors as determined by their wavelengths. Rays of violet, blue, green, yellow, orange and red light each have a specific wavelength, and when combined these colored rays create white light.

When transmittance of certain wavelengths into the eye is selectively reduced, e.g, through the use of sunglasses, glare can be reduced and contrast sensitivity can be enhanced. These conditions can provide the athlete with faster reaction speed, accuracy, clarity and comfort thereby affording possible key advantages over competitors.

Sunglasses have long been used to provide vision comfort to wearers by attenuating excessively bright lighting outdoors. However, these “fixed-tint” sunwear lenses can serve as a filter at only one level of illumination. The use of photochromic lenses can provide attenuation of bright lighting in accordance with the level of illuminance experienced. This dynamic filtering system relies upon hue, and filtering, to keep the optimum luminous intensity that reaches the eye close to 1400 cd/m2, which is considered the optimum level for comfortable vision. This is the intensity of light found, for example, under a shade tree in full sunlight. Such photochromic lenses offer a dynamic system that provides a level of darkness that automatically adjusts in relationship to the solar irradiation intensity, in particular the UV intensity, in proportional relationship to the visible light illumination conditions.

In most sports activities, visual clues are the most relied upon physical sense. Whether identifying terrain features, or minimizing reaction time in hand-eye responses, enhanced contrast of an object to its surrounding environment is of benefit. The best tint for sport sunwear lenses, of course, depends on the environmental and lighting conditions experienced during outdoor play.

The use of color-enhancing polarizing lenses is known to provide color saturation, and chromatic and luminous contrast through the use of a trichroic contrast enhancer. This trichroic system, however, does not necessarily provide the best color enhancement for sports activities. Also known is a fixed tint lens that provides an optical filter having an object contrast spectral window and a background spectral window. This is a static spectral attenuation lens system limited, as are other “fixed-tint” sunwear products, to providing the proper attenuation only at one solar irradiance intensity.

Other references describe a photochromic object with permanently increased contrast. Such an object is a normal gray photochromic system with a fixed tint dye that reduces the intensity of all wavelengths in the 380 to 500 nm range to a maximum of 30% transmittance and a minimum of 5% transmittance. This limits the color utility of this product when in lower lighting conditions.

Additionally, there are sunwear products available commercially that include different colored lenses that can be snapped onto the sunwear frames to change colors depending upon the light conditions experienced by the wearer (e.g., yellow/orange/red colored lenses for low lighting conditions and purple, dark amber or brown colored lenses for bright lighting conditions).

A number of sunwear products feature high transmission yellow, orange, red or amber lenses that can diminish the transmission of violet, blue, blue green, and green colors. Such products can reduce or eliminate scattered blue light associated with fog or haze, and increase visual acuity in low lighting conditions. However, this region of the spectrum is the trigger for pupillary function. Thus use of such lenses can result in reduced pupillary constriction in bright lighting conditions. The net effect for the wearer is eye discomfort in bright lighting conditions.

Optical articles, such as sport lenses, include non-prescription eyewear, prescription eyewear, and semi-finished lens blanks designed to be surfaced to desired prescriptions. Optical articles such as sport lenses also include contact lenses, goggles, visors, face shields, eye shields, helmets, and the like. Sports for which specific lenses may be designed can include but are not limited to: shooting, hunting, cycling, running, hiking, rock climbing, soccer, tennis, fishing, golfing, water sports, skiing, baseball, snowboarding, snowmobiling, basketball, handball, racquetball and motorcycling.

Sport lenses typically include polarized lenses, particularly for use in water sports, fishing, or driving sports where reflective glare is particularly troublesome. A fixed-tint colorant can be added as a component of the lens material used in the preparation of the lens, or to the polarizer (e.g., a polarizing coating or a polarizing film) which comprises a polarized lens. Polarized optical articles such as lenses reduce glare by blocking light which has become polarized by being reflected off various surfaces, particularly horizontal surfaces. Polarized optical articles such as sports sunwear lenses reduce glare so athletes can see the ball or other players better, or the fisherman can look into the water as opposed to viewing surface reflections. Anti-reflective (AR) coating(s) can be applied to the optical article as another glare reducer that works even at night, for example, for night sports played under bright lights. For the ultimate light-control lenses, many opticians recommend adding anti-reflective coating to lenses to eliminate glare from the “bounce-back” of light from the back surface of the lenses. This is particularly important for dark lenses because these back-side reflections are constant, and thus become more annoying as the intensity of the object transmitted through the lens is attenuated significantly, and begins to approach the intensity of the back-side reflections. Such lenses also can include UV block technology to provide 100% UVA/UVB protection as an added benefit of both short term and long term vision protection from harmful UV irradiation. Also, “mirror” coatings may be applied to such lenses to provide enhanced aesthetics (i.e., fashion lenses) as well as enhanced reflection of glare irradiance.

Notwithstanding the foregoing, there remains a need in the sports eyewear market for an optical article such as a lens or visor that enhances contrast in low lighting conditions (such as a yellow, orange, red, or amber color in low lighting conditions), but in brighter lighting conditions darkens significantly to provide excellent glare protection from excessive illumination. Additionally, through proper dye selection this darkened state color can be selected to enhance contrast between an object of interest and its environmental background colors.

### SUMMARY OF THE INVENTION

The present invention is directed to an optical article comprising (A) a substrate; and (B) a colorant composition connected to at least a portion of the substrate, the colorant composition comprising (1) a fixed-tint colorant; and (2) a photochromic material, wherein the article exhibits a passive state and an activated state, such that the article can switch from the passive state to the activated state in response to at least actinic radiation and revert back to the passive state in response to thermal energy, and wherein the passive state is characterized by a transmittance ranging from greater than 30% to 70% across a wavelength range of from 460 nanometers to 500 nanometers.

### BRIEF DESCRIPTION OF THE FIGURE(S)

Various embodiments of the present invention will be better understood when read in conjunction with the figures, in which:

FIG. 1 shows the spectra (percent transmittance versus wavelength) of the passive state and activated state of a lens coated with the composition of Example 1 prepared;

FIG. 2 shows the spectra (percent transmittance versus wavelength) of the passive state and activated state of a lens coated with the composition of Example 2;

FIG. 3 shows the spectra (percent transmittance versus wavelength) of the passive state and activated state of a lens coated with the composition of the Comparative Example;

FIG. 4 shows the reflected luminance of a golf ball, artificial grass and the combination of a golf ball on artificial grass over a wavelength range from 300 to 700 nm and

FIG. 5 shows the reflected luminance of a golf ball on artificial grass unfiltered and measured as viewed through lenses coated with the compositions of Examples 1 and 2.

### DETAILED DESCRIPTION OF THE INVENTION

As used in this specification and the appended claims, the articles “a,” “an,” and “the” include plural referents unless expressly and unequivocally limited to one referent.

Additionally, for the purposes of this specification, unless otherwise indicated, all numbers expressing quantities of ingredients, reaction conditions, and other properties or parameters used in the specification are to be understood as being modified in all instances by the term “about.” Accordingly, unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

Further, while the numerical ranges and parameters setting forth the broad scope of the invention are approximations as discussed above, the numerical values set forth in the Examples section are reported as precisely as possible. It should be understood, however, that such numerical values inherently contain certain errors resulting from the measurement equipment and/or measurement technique.

As previously mentioned, the present invention is directed to an optical article comprising (A) a substrate; and (B) a colorant composition connected to at least a portion of the substrate. The colorant composition comprises (1) a fixed-tint colorant; and (2) a photochromic material, wherein the article exhibits a passive state and an activated state, such that the article can switch from the passive state to the activated state in response to at least actinic radiation and revert back to the passive state in response to thermal energy, and wherein the passive state is characterized by a transmittance ranging from greater than 30% to 70% across a wavelength range of from 460 nanometers to 500 nanometers. This stated transmittance range within the stated wavelength range is quite relevant for lenses worn during outdoor activities where enhanced contrast between an observed object (e.g., a golf ball or a tennis ball) and its surrounding environment (e.g., grass or sky) can be advantageous.

For purposes of the present invention the “colorant composition” is not necessarily required to be a physical blend or a mixture of the colorant composition components, i.e., the fixed-tint colorant (1) and the photochromic material (2), although it may be. The optical article, however, must comprise both the fixed-tint colorant (1) and the photochromic material (2). Also it should be noted that the optical article of the present invention can comprise one or more fixed-tint colorants, and one or more photochromic materials.

As used herein the term “optical” means pertaining to or associated with light and/or vision. For example, according to various non-limiting embodiments disclosed herein, the optical article can be chosen from ophthalmic elements and devices, display elements and devices, windows, mirrors, and active and passive liquid crystal cell elements and devices. As used herein the term “ophthalmic” means pertaining to or associated with the eye and vision. Non-limiting examples of ophthalmic elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors. As used herein the term “mirror coating” means a surface coating that specularly reflects a large fraction of incident light.

The present invention affords a dynamic color filtration system in the form of an optical article (for example, sun wear lenses) providing one color under low lighting conditions (i.e., in the lightened or “passive” state) and another color under brighter lighting conditions (i.e., in the “activated” state). The color of both the low lighting and the brighter lighting conditions are specifically tailored to provide a spectral filtration system that accentuates object detectability and surrounding environment landscape interpretational clues. Specifically, under lower lighting conditions, the reduced transmission of violet and blue scattered light afforded by properly selected passive state color of the lens can enhance vision in hazy or foggy conditions. Under bright illumination conditions, the photochromic material appropriately darkens to effectively mitigate veiling glare and enhance certain colors while mitigating other colors. Thus the optical article of the present invention exhibits improved contrast between the object of interest and the surrounding background environment.

Contrast between two objects is defined by the ratio of the difference between two luminances (L1 and L2), to the sum thereof (that is: (L1−L2)/(L1+L2)). Through the proper selection of a colorant composition including fixed tint colorants such as pigments and/or dyes and photochromic materials, a dynamic lens filtration system can be produced that maximizes mesopic vision in low lighting conditions. This same dynamic lens can darken non-uniformly spectrally resulting in enhancement of the background color relative to the object of interest, or of the object of interest relative to its background. In both cases, the effective result is enhanced contrast. Additionally the darkening ability of the lens is specifically tailored to maintain the proper viewing luminance at all levels of varying light intensity to provide optimal visual acuity.

For example, the optimal sport lens for a tennis player may be one requiring improved contrast between the tennis ball and the background color of the court or the sky in bright light conditions. In golf, this sport lens can enhance contrast between light and dark patterns of the grass on greens, enabling you to “read” greens better for more accurate putting. Alternatively, it may be an enhancement of the hue of a hazy gray-blue sky to a deeper blue sky, resulting in the golf ball in flight standing out relative to the deeper blue colored sky. Amber or rose ski goggle lenses enhance soft grays that mark shadows on a ski slope. Because these shadows indicate ridges or bumps in the surface, skiers and snowboarders “read” them to decide when to turn, so they won't catch an edge and fall.

As mentioned above, both the level of contrast and the lighting environment are important factors to consider for sport lenses. Each color or tint has particular advantages in particular circumstances. By combining specific fixed-tint colorants, and specific photochromic materials, the optimum sun lens solution can be designed through selective spectral performance in response to varying light conditions to enhance vision for any desired sport. For example, this optimal sport lens could provide maximum contrast between the tennis ball and the court color for a tennis player; or it may mute the color of the grass to allow a golfer to be able to read the shadowing effect associated with the undulations of a green properly.

### Substrates:

Generally speaking, substrates that are suitable for use in the optical article of the present invention, can include but are not limited to, substrates formed from organic materials, inorganic materials, e.g., glass, or combinations thereof (for example, composite materials).

Specific examples of organic materials that may be used to form the substrates disclosed herein include polymeric materials, for examples, homopolymers and copolymers, prepared from the monomers and mixtures of monomers disclosed in U.S. Pat. No. 5,962,617 and in U.S. Pat. No. 5,658,501 from column 15, line 28 to column 16, line 17, the disclosures of which U.S. patents are specifically incorporated herein by reference. For example, such polymeric materials can be thermoplastic or thermoset polymeric materials, can be transparent or optically clear, and can have any refractive index required.

Examples of such disclosed monomers and polymers include: polyol(allyl carbonate) monomers, e.g., allyl diglycol carbonates such as diethylene glycol bis(allyl carbonate), which monomer is sold under the trademark CR-39® by PPG Industries, Inc.; polyurethane, poly(urea)urethane (which can prepared, for example, by the reaction of a polyurethane prepolymer and a diamine curing agent, a composition for one such polymer being sold under the trademark TRIVEX® by PPG Industries, Inc.), polythiourethane, polythio(urea)urethane; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride)poly(vinyl alcohol); poly(vinyl chloride); polysulfone; polyethylene; polypropylene; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, and polymers prepared by reacting polyfunctional isocyanates with polythiols or polyepisulfide monomers, either homopolymerized or co- and/or terpolymerized with polythiols, polyisocyanates, polyisothiocyanates and optionally ethylenically unsaturated monomers or halogenated aromatic-containing vinyl monomers. Also contemplated are copolymers of such monomers and blends of the described polymers and copolymers with other polymers, for example, to form block copolymers or interpenetrating network products.

In a particular embodiment, the substrate can comprise polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, copolymers thereof, and/or mixtures thereof.

The substrate may further comprise a protective coating on at least a portion of its surface. As used herein, the term “protective coating” refers to coatings or films that can prevent wear or abrasion, provide a transition in properties from one coating or film to another, protect against the effects of polymerization reaction chemicals and/or protect against deterioration due to environmental conditions, such as, moisture, heat, ultraviolet light, oxygen, etc. For example, commercially available thermoplastic polycarbonate ophthalmic lens substrates are often sold with an abrasion-resistant coating already applied to their surfaces because these surfaces tend to be readily scratched, abraded or scuffed. An example of one such polycarbonate lens substrate is sold under the trademark GENTEX (by Gentex Optics). Non-limiting examples of abrasion-resistant coatings include, abrasion-resistant coatings comprising silanes, abrasion-resistant coatings comprising radiation-cured acrylate-based thin films, abrasion-resistant coatings based on inorganic materials, such as, silica, titania and/or zirconia, and combinations thereof. For example, according to various non-limiting embodiments the protective coating may comprise a first coating of a radiation-cured acrylate-based thin film and a second coating comprising a silane. Non-limiting examples of commercial protective coatings products include SILVUE® 124 and HI-GARD® coatings, commercially available from SDC Coatings, Inc. and PPG Industries, Inc., respectively.

### Colorant Composition:

As mentioned above, the optical article of the present invention further comprises (B) a colorant composition connected to the substrate. The colorant composition comprises as components (1) a fixed-tint colorant, and (2) a photochromic material. As previously mentioned, the colorant composition need not be a physical mixture or blend of components (1) and (2) (although in some embodiments of the present invention components (1) and (2) may be blended and even present in the same composition which is applied to the substrate). Rather, the optical article of the present invention must comprise both components (1) and (2). For example, the fixed-tint colorant (1) may be present in/on the substrate, while the photochromic material (2) may be applied over that substrate as a separate coating or as a film comprising the photochromic material (2). Likewise, the photochromic material (2) may be present in/on the substrate and the fixed-tint colorant (1) can be applied over the photochromic substrate as a coating or as a film comprising the fixed-tin colorant (1). A myriad of combinations are possible provided both components (1) and (2) are present in the optical article.

Examples of suitable fixed-tint colorants can include, any of the art recognized inorganic and organic pigments and/or dyes. Organic dyes can include any of those selected from azo dyes, polymethyne dyes, arylmethyne dyes, polyene dyes, anthracinedione dyes, pyrazolone dyes, anthraquinone dyes, auinophtalone dyes and carbonyl dyes Specific examples of such organic dyes include Celliton Orange R and Celliton Yellow 7GFL available from BASF Corporation, Resolin Brilliant Yellow PGG available from Bayer, Samaron Brilliant Orange GSL available from Dystar, Terasil Orange R available from Ciba, Dorospers Orange R available from Dohmen Yellow2 GH, Yellow Yc, and Violet PF available from Keystone Aniline, Morplas Blue from Morton International, Inc., and Rubine Red from Clariant Corporation. Mixtures of any of the aforementioned dyes can be used.

As used herein, the term “photochromic material” includes both inorganic and organic photochromic materials, and both thermally reversible and non-thermally reversible (or photo-reversible) photochromic compounds. These photochromic materials can be employed in a wide variety of combinations in the colorant composition used to prepare the optical article of the present invention provided at least one thermally reversible photochromic compound is included. Generally, although not limiting herein, when two or more photochromic materials are used in conjunction with each other, the various materials can be chosen to complement one another to produce a desired color or hue. For example, mixtures of photochromic compounds can be used according to certain non-limiting embodiments disclosed herein to attain certain colors in the activated state, for example, a near neutral gray or near neutral brown. See, for example, U.S. Pat. No. 5,645,767, column 12, line 66 to column 13, line 19, the disclosure of which is specifically incorporated by reference herein, which describes the parameters that define neutral gray and brown colors.

The photochromic material can comprise any of a variety of organic and inorganic photochromic materials. The photochromic material(s) can include but is not limited to the following classes of materials: chromenes, e.g., naphthopyrans, benzopyrans, indenonaphthopyrans, phenanthropyrans or mixtures thereof; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides and mixtures of such photochromic compounds.

Such photochromic materials and complementary photochromic materials are described in U.S. Pat. Nos. 4,931,220 at column 8, line 52 to column 22, line 40; 5,645,767 at column 1, line 10 to column 12, line 57; 5,658,501 at column 1, line 64 to column 13, line 17; 6,153,126 at column 2, line 18 to column 8, line 60; 6,296,785 at column 2, line 47 to column 31, line 5; 6,348,604 at column 3, line 26 to column 17, line 15; and 6,353,102 at column 1, line 62 to column 11, line 64, the disclosures of the aforementioned patents are incorporated herein by reference. Spiro(indoline)pyrans are also described in the text, Techniques in Chemistry, Volume III, “Photochromism”, Chapter 3, Glenn H. Brown, Editor, John Wiley and Sons, Inc., New York, 1971.

Suitable photochromic materials can include polymerizable photochromic materials, such as polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzothiopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated naphthopyrans disclosed in U.S. Pat. No. 6,113,814 at column 2, line 23 to column 23, line 29; and the polymerizable photochromic compounds disclosed in WO97/05213 and in U.S. Pat. No. 6,555,028 at column 1, line 16 to column 24, line 56. The disclosures of the aforementioned patents on polymerizable photochromic materials are incorporated herein by reference.

Other suitable photochromic materials can include organo-metal dithiozonates, e.g., (arylazo)-thioformic arylhydrazidates, e.g., mercury dithizonates which are described in, for example, U.S. Pat. No. 3,361,706 at column 2, line 27 to column 8, line 43; and fulgides and fulgimides, e.g., the 3-furyl and 3-thienyl fulgides and fulgimides, which are described in U.S. Pat. No. 4,931,220 at column 1, line 39 through column 22, line 41, the disclosures of which are incorporated herein by reference.

Further photochromic material can include organic photochromic material resistant to the effects of a polymerization initiator when used. Such organic photochromic materials include photochromic compounds in admixture with a resinous material that has been formed into particles and encapsulated in metal oxides, which are described in U.S. Pat. Nos. 4,166,043 and 4,367,170 at column I line 36 to column 7, line 12, which disclosure is incorporated herein by reference.

The photochromic material can comprise a single photochromic compound; a mixture of photochromic compounds; a material comprising at least one photochromic compound, such as a plastic polymeric resin or an organic monomeric or oligomeric solution; a material such as a monomer or polymer to which at least one photochromic compound is chemically bonded; a material comprising and/or having chemically bonded to it at least one photochromic compound, the outer surface of the material being encapsulated (encapsulation is a form of coating), for example with a polymeric resin or a protective coating such as a metal oxide that prevents contact of the photochromic material with external materials such as oxygen, moisture and/or chemicals that have a negative effect on the photochromic material, such materials can be formed into a particulate prior to applying the protective coating as described in U.S. Pat. Nos. 4,166,043 and 4,367,170; a photochromic polymer, e.g., a photochromic polymer comprising photochromic compounds bonded together; or mixtures thereof.

Suitable photochromic materials can include polymerizable photochromic materials, for example, the polymerizable polyalkoxylated naphthopyrans disclosed in U.S. Pat. No. 6,113,814, at column 2, line 24 to column 23, line 29, the cited portions of which are incorporated herein by reference. Additionally, suitable photochromic materials can include polymeric matrix compatibilized naphthopyran compounds such as those disclosed in U.S. Pat. No. 6,555,028 B2 at column 2, line 40 to column 24, line 56, the cited portions of which are incorporated herein by reference.

Further, the photochromic material can comprise a reaction product of at least one ring-opening cyclic monomer comprising a cyclic ester and/or a cyclic carbonate, and a photochromic initiator. Such materials and the preparation thereof are described in detail in U.S. Patent Application Publication No. 200610022176A1 at paragraphs [0007] to [0088], the cited portions of which are incorporation herein by reference.

To enhance kinetics of any photochromic materials present in the optical article of the present invention, one or more art recognized plasticizers also may be used in conjunction with the photochromic material. Suitable plasticizers useful in the present invention can include the generally known classes of plasticizers. Examples of the classes of plasticizers are listed in Table 117, Chemical Names of Plasticizers and their Brand Names, pp 140-188, of Plasticizer Evaluation and Performance by Ibert Mellan, Noyes Development Corporation, 1967; in Ullmann's Encyclopedia of Industrial Chemistry, Vol. 20, pp 439-458, 1992, and in Modern Plastics Encyclopedia, Mid-November 1998 Issue, volume 75, Number 12, pages C-105 to C-115.

The various classes of plasticizers contemplated for use herein can include, but are not limited to: abietates, e.g. methyl abietate; acetates, e.g., glycidyl triacetate; adipates, e.g., dibutyl adipate; azelates, e.g., diisoocytyl azelate; benzoates, e.g., polyethyleneglycol dibenzoate; biphenyls, e.g., camphor; caprylates, e.g., butanediol dicaprylate; citrates, e.g., triethyl citrate; dodecanedioates, e.g., dioctyl dodecanedioate; ethers, e.g., dibenzyl ether; fumarates, e.g., diocytyl fumarate; glutarates, e.g., diisodecyl glutarate; glycolates, e.g., di(2-ethylhexyl)diglycolate; isophthalate, e.g., dimethyl isophthalate; laurates, e.g., poly(ethylene glycol)monolaurate; maleates, e.g., dibutyl maleate; myristates, e.g., isopropyl myristate; oleates, e.g., methyloleate; palmitates, e.g., tetrahydrofurfuryl palmitate; paraffin derivatives, e.g., chlomenate paraffin; phosphates, e.g., 2-ethylhexyl diphenyl phosphate and triphenyl phosphate; phthalates, e.g., diethyl phthalate and dioctyl phthalate; ricinoleates, e.g., methoxyethyl ricinoleate; sebacates, e.g., diethyl sebacate; stearates, e.g., methylpentachlorostearate; sulfonamides, e.g., toluene sulfonamide; tartrates, e.g., butyl tartrates; terephthalates, e.g., dioctyl terephthalate; trimellitates, e.g., trioctyl trimellitate and mixtures of such plasticizers.

Examples of suitable plasticizers also can include, where appropriate, organic polyols such as: (a) polyester polyols; (b) polyether polyols; (c) amide-containing polyols; (d) polyhydric polyvinyl alcohols; and (e) mixtures of such polyols. Such organic polyols and their preparation are well known in the art.

It should be noted that any of the fixed-tint colorants and/or the photochromic materials mentioned above may be incorporated into at least a portion of a coating composition prior to application of the coating composition to the substrate, or alternatively, a coating composition may be applied to the substrate, at least partially set, and thereafter the photochromic material may be imbibed into at least a portion of the coating. As used herein with reference to coatings, coating compositions, or components thereof, the terms “set” and “setting” are intended to include processes, such as, but not limited to, curing, polymerizing, cross-linking, cooling, and drying. As mentioned above either or both of the fixed-tint colorant and the photochromic material can be applied to the substrate (for example, in the form of a coating or imbibed into the surface of the substrate) and another fixed-tint colorant and/or photochromic material subsequently can be applied. Alternatively, the fixed-tint colorant and/or the photochromic material can be incorporated in mass into the materials used to form the substrate, and, optionally a fixed-tint colorant and/or a photochromic material subsequently can be applied to that substrate.

Specific non-limiting examples of coating compositions into which the fixed-tint colorants and/or photochromic materials may be incorporated include, but are not limited to, those coating compositions known in the art for use in connection with photochromic materials. Non-limiting examples of a coating compositions into which the photochromic materials according to various non-limiting embodiments disclosed herein may be incorporated include the mono-isocyanate containing coating compositions disclosed in U.S. Pat. No. 6,916,537 (“the '537 Patent”) at col. 3, lines 1 to 12, which comprises (in addition to a photochromic material) a reaction product (non-limiting examples which are set forth in the '537 Patent at col. 7, lines 4-37) of a polyol comprising at least one carbonate group (non-limiting examples of which are set forth in the '537 Patent at col. 7, line 38 to col. 8, line 49) and an isocyanate comprising at least one reactive isocyanate group and at least one polymerizable double bond (non-limiting examples of which are set forth in the '537 Patent at col. 8, line 50 to col. 9, line 44), and which optionally comprises an addition copolymerizable monomer (non-limiting examples of which are set forth in the '537 Patent at col. 11, line 47 to col. 20, line 43). The above-referenced disclosure of the '537 Patent is hereby specifically incorporated by reference herein.

Other non-limiting examples of suitable coating compositions into which the fixed-tint colorants and/or the photochromic materials may be incorporated include the poly(urea-urethane) compositions disclosed in U.S. Pat. No. 6,531,076, at col. 3, line 4 to col. 10, line 49, which disclosure is hereby specifically incorporated by reference herein. Still other non-limiting examples of coating compositions into which the photochromic materials according to various non-limiting embodiments disclosed herein may be incorporated include the polyurethane compositions disclosed in U.S. Pat. No. 6,187,444, at col. 2, line 52 to col. 12, line 15, which disclosure is hereby specifically incorporated by reference herein.

Yet other non-limiting examples of coating compositions into which the fixed tint colorants and/or the photochromic materials may be incorporated include the poly(meth)acrylic coating compositions described in U.S. Pat. No. 6,602,603, at col. 2, line 60 to col. 7, line 50; the aminoplast resin coating compositions described in U.S. Pat. No. 6,506,488, at col. 2, line 43 to col. 12, line 23 and U.S. Pat. No. 6,432,544, at col. 2, line 32 to col. 14, line 5; the polyanhydride coating compositions described in U.S. Pat. No. 6,436,525, at col. 2, line 15 to col. 11, line 60; the epoxy resin coating compositions described in U.S. Pat. No. 6,268,055, at col. 2, line 63 to col. 17, line 3; and the alkoxyacrylamide coating compositions descried in U.S. Pat. No. 6,060,001, at col. 2, line 6 to col. 5, line 39. The above-referenced disclosures are hereby specifically incorporated by reference herein.

Further, it will be appreciated by those skilled in the art that the coating compositions described above may further comprise other additives that aid in the processing and/or performance of the composition or coating derived therefrom. Non-limiting examples of such additives include photoinitiators, thermal initiators, polymerization inhibitors, solvents, light stabilizers (such as, but not limited to, ultraviolet light absorbers and light stabilizers, such as, hindered amine light stabilizers (HALS)), heat stabilizers, mold release agents, rheology control agents, leveling agents (such as, but not limited to, surfactants), free radical scavengers, adhesion promoters (such as, hexanediol diacrylate and coupling agents), and combinations and mixtures thereof.

Non-limiting examples of additional coatings and films that may be used in conjunction with the optical articles disclosed herein can include, but are not limited to, primer or compatiblizing coatings; protective coatings, including transitional coatings, abrasion-resistant coatings and other coatings that protect against the effects of polymerization reaction chemicals and/or protect against deterioration due to environmental conditions, such as, moisture, heat, ultraviolet light, and/or oxygen (e.g., UV-shielding coatings and oxygen barrier coatings); anti-reflective coatings; conventional photochromic coating; reflective coatings including mirror coatings; polarizing coatings and polarizing films; and combinations thereof.

Non-limiting examples of primer or compatiblizing coatings that may be used in conjunction with various non-limiting embodiments disclosed herein include coatings comprising coupling agents, at least partial hydrolysates of coupling agents, and mixtures thereof. As used herein, the term “coupling agent” means a material having a group capable of reacting, binding and/or associating with a group on a surface. Coupling agents according to various non-limiting embodiments disclosed herein may include organometallics, such as, silanes, titanates, zirconates, aluminates, zirconium aluminates, hydrolysates thereof, and mixtures thereof. As used herein, the phrase “at least partial hydrolysates of coupling agents” means that some to all of the hydrolyzable groups on the coupling agent are hydrolyzed. Other non-limiting examples of primer coatings that are suitable for use in conjunction with the various non-limiting embodiments disclosed herein include those primer coatings described U.S. Pat. No. 6,025,026 at col. 3, line 3 to col. 11, line 40 and U.S. Pat. No. 6,150,430 No. at col. 2, line 39 to col. 7, line 58, which disclosures are hereby specifically incorporated herein by reference.

As used herein, the term “transitional coating” means a coating that aids in creating a gradient in properties between two coatings. For example, although not limiting herein, a transitional coating may aid in creating a gradient in hardness between a relatively hard coating (such as, an abrasion-resistant coating) and a relatively soft coating (such as, a photochromic coating). Non-limiting examples of transitional coatings include radiation-cured, acrylate-based thin films as described in U.S. Patent Application Publication No. 2003/0165686 at paragraphs [0079]-[0173], which are hereby specifically incorporated by reference herein.

As used herein, the term “abrasion-resistant coating” refers to a protective polymeric material that demonstrates a resistance to abrasion that is greater than a standard reference material, e.g., a polymer made of CR-39® monomer available from PPG Industries, Inc, as tested in a method comparable to ASTM F-735 Standard Test Method for Abrasion Resistance of Transparent Plastics and Coatings Using the Oscillating Sand Method. Non-limiting examples of abrasion-resistant coatings include abrasion-resistant coatings comprising organosilanes, organosiloxanes, abrasion-resistant coatings based on inorganic materials, such as, silica, titania and/or zirconia, and organic abrasion-resistant coatings of the type that are ultraviolet light curable.

Non-limiting examples of antireflective coatings include a monolayer coating or multilayer coatings of metal oxides, metal fluorides, or other such materials, which may be deposited onto the articles disclosed herein (or onto self supporting films that are applied to the articles as discussed herein below), for example, through vacuum deposition, sputtering, etc.

In a particular embodiment of the present invention, the optical article further comprises a polarizer comprised of a polarizing coating layer and/or a polarizing stretched film. Non-limiting examples of polarizing coatings and polarizing stretched-films include, but are not limited to, polarizing coatings (such as those described in U.S. Patent Application Publication No. 2005/0151926, at paragraphs [0029]-[0116], which are hereby specifically incorporated by reference herein), and polarizing stretched-films comprising dichroic compounds that are known in the art.

As discussed above, according to various non-limiting embodiments an additional at least partial coating or film may be formed on the substrate prior to connecting the colorant composition or a component thereof (i.e., either the fixed-tint colorant or the photochromic material) on or to the substrate. For example, according to certain non-limiting embodiments a primer or compatiblizing coating may be formed on the substrate prior to applying the colorant composition or a component thereof. Additionally or alternatively, one or more additional at least partial coating(s) may be formed on the substrate after connecting the colorant composition or a component thereof on or to the substrate, for example, as an overcoating on the colorant composition. For example, a transitional coating may be formed over the colorant composition, and an abrasion-resistant coating may then be formed over the transitional coating.

For example, according to certain non-limiting embodiments there is provided a optical article comprising a substrate (such as, but not limited to a piano-concave or a piano-convex ophthalmic lens substrate), which comprises an abrasion-resistant coating on at least a portion of a surface thereof; a primer or compatiblizing coating on at least a portion of the abrasion-resistant coating; a colorant composition in the form of a coating, on at least a portion of the primer or compatiblizing coating; a transitional coating on at least a portion of the colorant composition in the form of a coating; and an abrasion-resistant coating on at least a portion of the transitional coating. Further, the optical article also may comprise, for example, an antireflective coating that is connected to a surface of the substrate and/or a polarizing coating or film that is connected to a surface of the substrate.

The colorant composition or a component thereof (i.e, either the fixed-tint colorant or the photochromic material) can be connected to at least a portion of a substrate by at least one of in-mold casting, coating and imbibition, and lamination as discussed below,

Non-limiting methods of incorporating the fixed-tint colorants and/or the photochromic materials into an organic material include, for example, mixing the fixed-tint colorants and/or photochromic material into a solution or melt of a polymeric or oligomeric material, and subsequently at least partially setting the polymeric or oligomeric material (with or without bonding the fixed-tint colorants and/or the photochromic materials to the organic material); mixing the fixed-tint colorants and/or photochromic materials with a monomeric material and subsequently at least partially polymerizing the monomer (with or without co-polymerizing the photochromic material with the monomer or otherwise bonding the fixed-tint colorants and/or photochromic material to the resultant polymer or intermediate in the polymerization reaction as previously discussed); and imbibing the fixed-tint colorants and/or photochromic materials into a polymeric material (with or without bonding the photochromic material to the polymeric material).

If the substrate is formed from a polymeric material, the fixed-tint colorant and/or photochromic material may be connected to at least a portion of the substrate by the cast-in-place method and/or by imbibition. For example, in the cast-in-place method, the fixed-tint colorants and/or photochromic material may be mixed with a polymeric solution or melt, or other oligomeric and/or monomeric solution or mixture, which may be subsequently cast into a mold having a desired shape and at least partially set to form the substrate. Optionally, according to this non-limiting embodiment, the fixed-tint colorants and/or photochromic material may be bonded to a portion of the polymeric material of the substrate, for example, by co-polymerization with a monomeric precursor thereof or an intermediate in the polymerization reaction. In the imbibition method, the fixed-tint colorants and/or photochromic material may be diffused into the polymeric material of the substrate after it is formed, for example, by immersing a substrate in a solution containing the fixed-tint colorants and/or photochromic material, with or without heating. Thereafter, although not required, the fixed-tint colorants and/or photochromic material may be bonded with the polymeric material.

For example, according to one non-limiting embodiment wherein the substrate comprises a polymeric material, the colorant composition or a component thereof (i.e., either the fixed-tint colorant or the photochromic material) may be connected to at least a portion of a substrate by in-mold casting. According to this non-limiting embodiment, a coating composition comprising the colorant composition or a component thereof, which may be a liquid coating composition or a powder coating composition, may be applied to the surface of a mold and at least partially set. Thereafter, a polymer solution or melt, or oligomeric or monomeric solution or mixture may be cast over the coating and at least partially set. After setting, the coated substrate may be removed from the mold. Non-limiting examples of powder coatings in which the photochromic materials may be employed are set forth in U.S. Pat. No. 6,068,797 at col. 7, line 50 to col. 19, line 42, which disclosure is hereby specifically incorporated by reference herein.

Where the substrate comprises a polymeric material or an inorganic material, such as, for example, glass, the colorant composition (or either component thereof, i.e., either the fixed-tint colorant or the photochromic material) may be connected to at least a portion of a substrate by a coating process. Non-limiting examples of suitable coating processes include spin coating, spray coating (e.g., using a liquid or a powder coating compositions), curtain coating, roll coating, spin and spray coating, over-molding, and combinations thereof. For example, according to one non-limiting embodiment, the colorant composition may be connected to the substrate by over-molding. According to this non-limiting embodiment, a coating composition comprising the colorant composition or a component thereof (examples of which coatings are discussed above) may be applied to a mold and then a substrate may be placed into the mold such that the substrate contacts the coating causing it to spread over at least a portion of the surface of the substrate. Thereafter, the coating composition may be at least partially set and the coated substrate may be removed from the mold. Alternatively, the over-molding process may comprise placing the substrate into a mold such that an open region is defined between the substrate and the mold, and thereafter injecting a coating composition comprising the colorant composition or a component thereof into the open region. Thereafter, the coating composition may be at least partially set and the coated substrate may be removed from the mold. According to another non-limiting embodiment, the colorant composition or a component thereof may be connected to substrate by spin-coating a coating composition comprising one or both of the fixed-tint colorant and the photochromic material onto the substrate, for example, by rotating the substrate and applying the coating composition to the substrate while it is rotating and/or by applying the coating composition to the substrate and subsequently rotating the substrate.

Additionally or alternatively, a coating composition (with or without a fixed-tint colorant and/or a photochromic material) may be applied to a substrate (for example, by any of the foregoing coating processes), the coating composition may be at least partially set, and thereafter, a colorant composition or any component thereof may be into the coating.

As discussed above, after forming the coating comprising the fixed-tint colorant and/or the photochromic material at least a portion of the coating may be at least partially set. For example, at least partially setting at least a portion of the coating may comprise exposing the coating to at least one of electromagnetic radiation and thermal radiation to at least partially dry, polymerize and/or cross-link one or more components of the coating composition.

According to yet another non-limiting embodiment, wherein the substrate comprises a polymeric material or an inorganic material, such as, for example, glass, the colorant composition may be connected to at least a portion of a substrate by lamination. For example, according to this non-limiting embodiment, a self-supporting film or sheet comprising the colorant composition may be adhered or otherwise connected to a portion of the substrate, with or without an adhesive and/or the application of heat and pressure. Optionally, thereafter a protective coating may be applied over the film; or a second substrate may be applied over the first substrate and the two substrates may be laminated together (i.e., by the application of heat and pressure) to form an element wherein the film comprising the photochromic material is interposed between the two substrates. Methods of forming films comprising a fixed-tint colorant and/or photochromic material may include, for example and without limitation, combining a fixed-tint colorant and/or a photochromic material with a polymeric or oligomeric solution or mixture, casting or extruding a film therefrom, and, if required, at least partially setting the film. Additionally or alternatively, a film may be formed (with or without a colorant composition or a component thereof) and imbibed with the colorant composition or a component thereof.

Further, according to various non-limiting embodiments, prior to connecting the colorant composition to at least a portion of the substrate by coating, imbibitions, or lamination, a primer or compatiblizing coating (such as those discussed above) may be formed on at least a portion of the surface of the substrate to enhance one or more of the wetting, adhesion, and/or chemical compatibility of the photochromic coating with the substrate. Non-limiting examples of suitable primer or compatiblizing coatings and methods of making the same are disclosed above. Still further, as previously discussed according to various non-limiting embodiments disclosed herein, the substrate may comprise an abrasion-resistant coating on at least a portion of its surface.

According to various non-limiting embodiments disclosed herein, prior to applying any coating or film to the substrate, for example, prior to connecting the colorant composition to at least a portion of the surface of the substrate by coating and/or lamination or prior to applying a primer or compatiblizing coating to the substrate, the surface may be cleaned and/or treated to provide a clean surface and/or a surface that may enhance adhesion of the colorant composition to the substrate. Effective cleaning and treatments may include, but are not limited to, ultrasonic washing with an aqueous soap/detergent solution; cleaning with an aqueous mixture of organic solvent, e.g., a 50:50 mixture of isopropanol:water or ethanol:water; UV treatment; activated gas treatment, e.g., treatment with low temperature plasma or corona discharge; and chemical treatment that results in hydroxylation of the substrate surface, e.g., etching of the surface with an aqueous solution of alkali metal hydroxide, e.g., sodium or potassium hydroxide, which solution can also contain a fluorosurfactant. Generally, the alkali metal hydroxide solution is a dilute aqueous solution, e.g., from 5 to 40 weight percent, more typically from 10 to 15 weight percent, such as, 12 weight percent, alkali metal hydroxide. See, for example, U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials. The foregoing disclosures are specifically incorporated herein by reference.

In one non-limiting embodiment, surface treatment of the substrate may be a low temperature plasma treatment. Although not limiting herein, this method allows treatment of the surface to enhance adhesion of a coating formed thereon, and may be a clean and efficient way to alter the physical surface, e.g., by roughening and/or chemically altering the surface without affecting the rest of the article. Inert gases, such as, argon, and reactive gases, such as, oxygen, may be used as the plasma gas. Inert gases may roughen the surface, while reactive gases, such as, oxygen may both roughen and chemically alter the surface exposed to the plasma, e.g., by producing hydroxyl or carboxyl units on the surface. According to one non-limiting embodiment, oxygen may be used as the plasma gas. Although not limiting herein, it is considered that oxygen may provides a slight, but effective, physical roughening of the surface along with a slight, but effective, chemical modification of the surface. As will be appreciated by those skilled in the art, the extent of the surface roughening and/or chemical modification will be a function of the plasma gas and the operating conditions of the plasma unit (including the length of time of the treatment).

Various non-limiting embodiments disclosed herein further contemplate the use of various combinations of the forgoing methods to form photochromic articles according to various non-limiting embodiments disclosed herein. For example, and without limitation herein, according to one non-limiting embodiment, a fixed-tint colorant and/or photochromic material may be connected to substrate by incorporation into an organic material from which the substrate is formed (for example, using the cast-in-place method and/or imbibition), and thereafter a fixed-tint coloranty and/or a photochromic material (which may be the same or different from the aforementioned fixed-tint colorant and/or photochromic material) may be connected to a portion of the substrate using the in-mold casting, coating, and/or lamination methods discussed above.

According to various non-limiting embodiments, the fixed-tint colorants and the photochromic materials described herein may be used in amounts (or ratios) such that the optical article exhibits desired optical properties (e.g., color and transmittance).

As used herein the term “connected to” means incorporated into an object, or in direct contact with an object, or indirect contact with an object through one or more other structures or materials, at least one of which is in direct contact with the object. Thus, according to various non-limiting embodiments disclosed herein, the colorant composition can be incorporated into the substrate such as by an “in mass” application where all or a portion of the colorant composition, or at least one component thereof, is incorporated (i.e., mixed or blended into) the components used to prepare the substrate.
1. As mentioned above, the colorant composition can be applied directly to the substrate; or at least one component thereof can be applied directly to the substrate. For example, the substrate can comprise a photochromic material, and the fixed-tint colorant can be applied to the photochromic substrate; or, alternatively, the substrate can comprise a fixed-tint colorant and the photochromic material can be applied to the tinted substrate. Further, the colorant composition can be in indirect contact with the substrate, that is the colorant composition can be in contact with one or more at least partial coatings, polymer sheets or combinations thereof, at least one of which is in direct contact with at least a portion of the substrate. The optical article of the present invention can comprise a multilayer structure comprising the substrate and the colorant composition wherein the colorant composition or components (1) and (2) thereof are present in one or more layers of the multilayer structure, including in the substrate layer itself. For example, the colorant composition (B) can comprise a coating composition comprising at least one of the fixed-tint colorant (1) and the photochromic material (2), and the coating composition can be applied over a tinted or untinted substrate. Alternatively, the fixed-tint colorant (1) can be present in and/or on the substrate (A), and the photochromic material (2) can comprise a coating composition and/or a film connected to the substrate. Further, the photochromic material (2) can be present in and/or on the substrate (A), and the fixed-tint colorant (2) can comprise a coating composition and/or a film connected to the substrate.

It should also be noted that the colorant composition or a component thereof can be applied to an untinted substrate or to a tinted substrate. As used herein with reference to substrates the term “untinted” means substrates that are essentially free of coloring agent additions and have an absorption spectrum for visible radiation that does not vary significantly in response to actinic radiation. Further, with reference to substrates the term “tinted” means substrates that have a coloring agent addition and an absorption spectrum for visible radiation that may or may not vary significantly in response to actinic radiation.

The optical article of the present invention exhibits a passive state and an activated state, such that the article can switch from the passive state to the activated state in response to at least actinic radiation and to revert back to the passive state in response to thermal energy. In the “passive” state, the optical article of the present invention exhibits a first color (i.e, an absorption spectrum for visible radiation) due to the presence of the fixed-tint colorant which does not vary in response to actinic radiation. In the “activated” state, the optical article exhibits a second color due to the combined effect of the color of the fixed-tint colorant and the photochromic material which darkens (and colors) in response to at least actinic radiation. This effect is thermally reversible to the passive state.

In the passive state the optical article has a transmittance ranging from greater than 30% to 70%, typically 35% to 70%, across a wavelength range of from 460 nanometers (nm) to 500 nm. Further, in the passive state the spectral filtration ratio of the maximum transmittance in the wavelength range of from 460 nm to 500 nm to the minimum transmittance in the wavelength range from 500 nm to 580 nm ranges from 0.5 to 1.5, such as from 0.75 to 1.5, or from 1.0 to 1.5.

Further, in the activated state the spectral filtration ratio of the maximum transmittance in the wavelength range from 460 nm to 500 nm to the minimum transmittance in the wavelength range from 500 nm to 580 nm is greater than 1.0, such as greater than 2.0, or greater than 3.0. For purposes of the present invention, as used herein in the specification and in the claims, transmittance and spectral filtration ratio are each measured in accordance with the methods described in detail in the Examples herein below.

The invention is further described in conjunction with the following examples, which are to be considered as illustrative rather than limiting, and in which all parts are parts by weight and all percentages are percentages by weight unless otherwise specified.

### EXAMPLES

The present invention is more particularly described in the following examples, which are intended as illustrative only, since numerous modifications and variations therein will be apparent to those skilled in the art. Part 1 describes the preparation of the coating formulations of Examples 1 and 2; Part 2 describes the preparation of the coated lenses; Part 3 describes the photochromic performance testing of the lenses coated with Examples 1 and 2 and the Comparative Example a Rodenstock Colormatic Extra Contrast Orange lens; and Part 4 describes the luminance testing of a golf ball, artificial grass measured individually and combined as viewed through lenses coated with Examples 1 and 2.

In the examples, percentages are reported as weight percent, unless otherwise specified. Materials, such as dyes, polyols, catalysts, surfactants, etc., which are identified in one example by a lower case letter in parenthesis and which are used in other examples, are identified in the subsequent examples with the same lower case number.

### Part 1

### Preparation of Coating Formulations

### Example 1

The following materials were added in the order described to a suitable vessel equipped with an agitator.

CHARGE 1

| MATERIAL | WEIGHT PERCENT |
|---|---|
| NMP⁽¹⁾ | 24.5265 |
| YELLOW 2GH⁽²⁾ | 0.4341 |
| VIOLET PF⁽³⁾ | 0.4909 |
| MORPLAS BLUE⁽⁴⁾ | 0.0750 |
| PC-1⁽⁵⁾ | 0.9788 |
| PC-2⁽⁶⁾ | 1.4681 |
| IRGANOX ® 245⁽⁷⁾ | 0.8156 |
| TINUVIN ® 144⁽⁸⁾ | 0.8156 |

⁽¹⁾NMP is N-methylpyrrolidinone (biotechnical grade) available from Aldrich of Milwaukee, Wisconsin.
⁽²⁾Yellow dye from Keystone Aniline Corporation.
⁽³⁾Violet dye from Keystone Aniline Corporation.
⁽⁴⁾Blue dye from Morton International, Inc.
⁽⁵⁾A blue coloring photochromic indenonaphthopyran.
⁽⁶⁾A purple coloring photochromic indenonaphthopyran.
⁽⁷⁾IRGANOX ® 245 - An antioxidant/stabilizer available from Ciba Specialty Chemicals Corp.
⁽⁸⁾TINUVIN ®-144 is a light stabilizer of the hindered amine class reported to have CAS# 63843-89-0 and is available from Ciba Specialty Chemicals.

CHARGE 2

| MATERIAL | WEIGHT PERCENT |
|---|---|
| A-187⁽⁹⁾ | 1.9386 |
| K-KAT ® 348⁽¹⁰⁾ | 0.4894 |
| BYK ® 333⁽¹¹⁾ | 0.0367 |

⁽⁹⁾SILQUEST ® A-187 is A gamma-glycidoxypropyl trimethoxysilane, which is available from Osi Specities of Paris, France.
⁽¹⁰⁾K-KAT ®348 is a urethane catalyst reported to be a bismuth carboxylate available from King Industries Inc.
⁽¹¹⁾BYK ® 333 is a polyether modified dimethylpolysiloxane compolymer, which is available from BYK-Chemie of Wallingford, Connecticut.

CHARGE 3

| MATERIAL | WEIGHT PERCENT |
|---|---|
| NMP⁽¹⁾ | 3.6247 |
| PMAP⁽¹²⁾ | 15.0340 |
| PC-1122⁽¹³⁾ | 14.7517 |
| Desmodur ® PL-340⁽¹⁴⁾ | 9.1130 |
| HDI Biuret BI-7960⁽¹⁵⁾ | 25.9919 |

⁽¹²⁾A poly(meth)acrylic polyol produced by following the procedure of Composition D of Example 1 in U.S. Pat. No. 6,187,444, which procedure is incorporated herein by reference, except that in Charge 2, the styrene was replaced with methyl methacrylate and 0.5% by weight, based on the total monomer weight, of triphenyl phosphite was added.
⁽¹³⁾An aliphatic carbonate diol available form Stahl USA.
⁽¹⁴⁾A blocked IPDI (isophorone diisocyanate) available from Bayer Corp.
⁽¹⁵⁾A blocked hexamethylene diisocyanate available from Baxenden Chemical Co. of Lancashire, England.

Charge 1 was added to the vessel and mixed for approximately 30 minutes to dissolve the solids. Charge 2 was added to the solution and the resulting mixture was stirred for approximately 5 minutes. The materials of Charge 3 were added in the order listed to a separate container and mixed prior to adding it to the vessel containing Charges 1 and 2. The resulting mixture was placed in a 120 mL container and placed on a U.S. Stoneware Roll mixer at a dial setting of 40 for 2 hours.

### Example 2

The procedure of Example 1 was followed except that Charge 1A was used in place of Charge 1, Charge 2A was used in place of Charge 2 and Charge 3A was used in place of Charge 3.

CHARGE 1A

| MATERIAL | WEIGHT PERCENT |
|---|---|
| NMP⁽¹⁾ | 23.7642 |
| MORPLAS BLUE⁽⁴⁾ | 0.0500 |
| YELLOW Yc⁽¹⁶⁾ | 0.6700 |
| RUBINE RED⁽¹⁷⁾ | 0.2800 |
| PC-3⁽¹⁸⁾ | 2.9429 |
| IRGANOX ® 245⁽⁷⁾ | 0.9810 |
| TINUVIN ® 144⁽⁸⁾ | 0.9810 |

⁽¹⁶⁾Yellow dye from Keystone Aniline Corporation.
⁽¹⁷⁾Red dye from Clariant Corporation.
⁽¹⁸⁾A blue coloring photochromic indenonaphthopyran.

CHARGE 2A

| MATERIAL | WEIGHT PERCENT |
|---|---|
| A-187⁽⁹⁾ | 1.9429 |
| K-KAT ® 348⁽¹⁰⁾ | 0.4905 |
| BYK ® 333⁽¹¹⁾ | 0.0368 |

CHARGE 3A

| MATERIAL | WEIGHT PERCENT |
|---|---|
| NMP⁽¹⁾ | 3.6328 |
| PMAP⁽¹²⁾ | 15.0678 |
| PC-1122⁽¹³⁾ | 14.7849 |
| Desmodur ® PL-340⁽¹⁴⁾ | 9.1335 |
| HDI Biuret BI-7960⁽¹⁵⁾ | 26.0504 |

### Part 2

### Preparation of the Coated Lenses

Finished single vision polycarbonate lenses having a diameter of 76 mm obtained from Gentex Optics were used. The test lenses were treated with a corona discharge from a 3DT Multidyne unit operating at 60 Hertz and 1.3 kVA unit for 15 seconds The test lenses were then washed with soapy water, rinsed with deionized water and dried with air. The coatings of Examples 1 and 2 were each applied by spin-coating separately to corona treated lens and cured at 125° C. for 60 minutes. The resulting cured coatings were approximately 20 microns thick. The coated test lenses were treated by corona discharge from a 3DT Flexidyne unit operating at 20 Hertz and 0.70 kilowatts for 35 seconds and then rinsed with deionized water and dried. An acrylate-based formulation of the type described in Examples 1 and 2 of U.S. Pat. No. 7,410,691, which disclosure is incorporated herein by reference, was applied to the test lenses by spin coating and cured to result in coatings that were approximately 8 microns thick. The resulting coated test lenses were treated with a corona discharge from a 3DT Flexidyne unit operating at 20 Hertz and 0.70 kilowatts for 35 seconds and an organo silane-based abrasion-resistant coating was applied to the corona discharge treated surface of the coated lenses by spin coating. The lenses were then heated for 3 hours in a convection oven at 212° F. (100° C.). The thicknesses of the abrasion-resistant coatings were approximately 2 microns.

### Part 3

### Photochromic Performance Testing of the Coated Lenses

The photochromic performance of each of the aforementioned coated lenses was determined as follows. The coated lenses prepared in Part 2 and the Comparative Example lens were tested for photochromic response on the Bench for Measuring Photochromics (“BMP”) optical bench made by Essilor, Ltd. France. The optical bench was maintained at a constant temperature of 23° C. (73.4° F.) during testing.

Prior to testing on the optical bench, each of the coated lenses the Comparative Example lens were exposed to 365-nanometer ultraviolet light for about 10 minutes at a distance of about 12 centimeters to activate the photochromic materials. The UVA (315 to 380 nm) irradiance at the lens was measured with a Licor Model Li-1800 spectroradiometer and found to be 16.5 watts per square meter. The lens was then placed under a 500 watt, high intensity halogen lamp for about 10 minutes at a distance of about 32 centimeters to bleach (inactivate) the photochromic materials. The illuminance at the lens was measured with the Licor spectroradiometer and found to be 20 Klux. The lenses were then kept in a dark environment at room temperature (from 21° C. to 24° C., or 70° F. to 75° F.) for at least 1 hour prior to testing on an optical bench. Prior to optical bench measurement, the lenses were measured for ultraviolet absorbance at 390 and 405 nm.

The BMP optical bench was fitted with two 150-watt ORIEL® Model #66057 Xenon arc lamps at right angles to each other. The light path from Lamp 1 was directed through a 3 mm SCHOTT® KG-2 band-pass filter and appropriate neutral density filters that contributed to the required UV and partial visible light irradiance level. The light path from Lamp 2 was directed through a 3 mm SCHOTT® KG-2 band-pass filter, a SCHOTT® short band 400 nm cutoff filter and appropriate neutral density filters in order to provide supplemental visible light illuminance. A 5.1 cm×5.1 cm (2 inch×2 inch) 50% polka dot beam splitter, at 45° to each lamp is used to mix the two beams. The combination of neutral density filters and voltage control of the Xenon arc lamp were used to adjust the intensity of the irradiance. Proprietary software was used on the BMP to control timing, irradiance, air cell and sample temperature, shuttering, filter selection and response measurement. A ZEISS® spectrophotometer, Model MCS 501, with fiber optic cables for light delivery through the lens was used for response and color measurement. Photopic response measurements, as well as the response at four select wavelengths, were collected on each lens.

The power output of the optical bench, i.e., the dosage of light that the lens was exposed to, was adjusted to 6.7 Watts per square meter (W/m²) UVA, integrated from 315-380 nm and 50 Klux illuminance, integrated from 380-780 nm. Measurement of the power output was made using the optometer and software contained within the BMP.

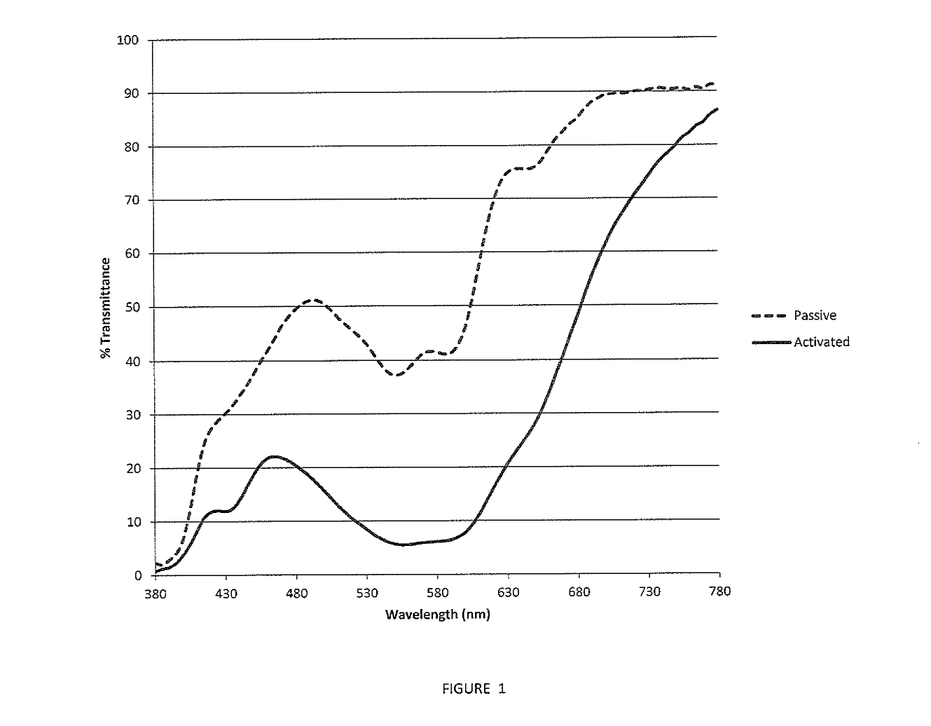

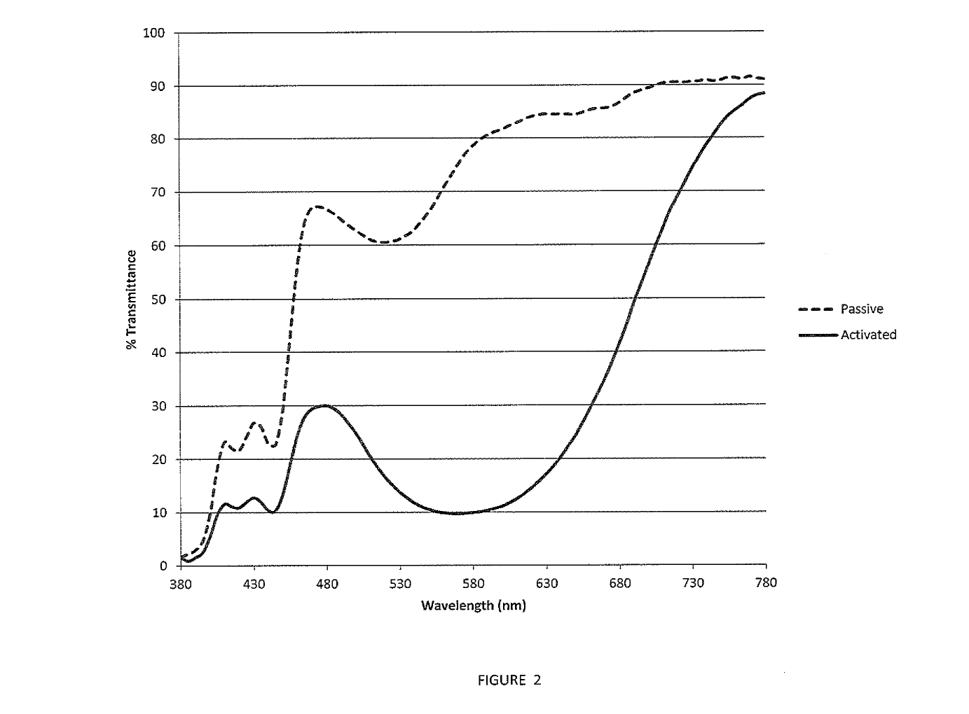

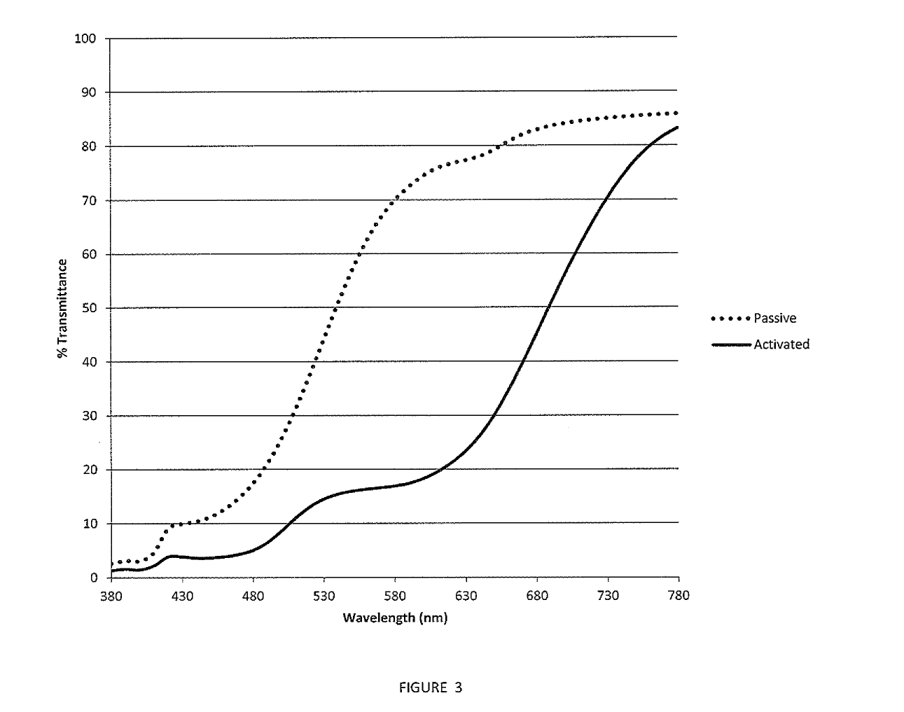

Response measurements, in terms of a change from the first state being unactivated or bleached to the second state being activated or colored in percent transmittance over the wavelength range from 380 to 780 nanometers, were determined by establishing the initial unactivated transmittance, opening the shutter from the Xenon lamp(s) and measuring the transmittance through activation at selected intervals of time. The results as percent transmittance for the wavelengths ranging from 460 to 580 nanometers are tabulated for Example 1 in Table 1 and graphically presented in FIG. 1, for Example 2 in Table 2 and FIG. 2 and for the Comparative Example a Rodenstock Colormatic Extra Contrast Orange in Table 3 and FIG. 3.

TABLE 1
Percent Transmittance for the Lens coated with Example 1

| Wavelength | | |
|---|---|---|
| (nm) | Passive | Activated |
| 460 | 43.07 | 22.24 |
| 470 | 47.06 | 22.00 |
| 480 | 50.37 | 20.39 |
| 490 | 52.54 | 18.34 |
| 500 | 51.98 | 15.67 |
| 510 | 49.19 | 12.73 |
| 520 | 46.66 | 10.31 |
| 530 | 44.01 | 8.32 |
| 540 | 39.84 | 6.57 |
| 550 | 36.42 | 5.47 |
| 560 | 37.09 | 5.34 |
| 570 | 39.80 | 5.72 |
| 580 | 39.96 | 5.96 |

The results in Table 1 for the lens coated with Example 1 indicate that the maximum passive transmittance in the 460-500 nm range is 52.54 and the minimum passive transmittance in the 500-580 range is 36.42 yielding an passive contrast ratio of 1.44; and the maximum activated transmittance in the 460-500 nm range is 22.24 and the minimum activated transmittance in the 500-580 range is 5.34 yielding an activated contrast ratio of 4.16.

TABLE 2
Percent Transmittance for the Lens coated with Example 2

| Wavelength | | |
|---|---|---|
| (nm) | Passive | Activated |
| 460 | 50.02 | 21.48 |
| 470 | 61.71 | 26.78 |
| 480 | 61.84 | 27.16 |
| 490 | 59.55 | 25.20 |
| 500 | 57.09 | 21.62 |
| 510 | 55.50 | 17.74 |
| 520 | 54.98 | 14.41 |
| 530 | 55.32 | 11.87 |
| 540 | 56.85 | 10.15 |
| 550 | 60.03 | 9.17 |
| 560 | 64.82 | 8.79 |
| 570 | 69.80 | 8.83 |
| 580 | 73.86 | 9.15 |

The results in Table 2 for the lens coated with Example 2 indicate that the maximum passive transmittance in the 460-500 nm range is 61.84 and the minimum passive transmittance in the 500-580 range is 54.98 yielding an passive contrast ratio of 1.12; and the maximum activated transmittance in the 460-500 nm range is 27.16 and the minimum activated transmittance in the 500-580 range is 8.79 yielding an activated contrast ratio of 3.09.

TABLE 3
Percent Transmittance for the Lens
coated with the Comparative Example

| Wavelength | | |
|---|---|---|
| (nm) | Passive | Activated |
| 460 | 12.66 | 3.86 |
| 470 | 14.70 | 4.28 |
| 480 | 17.43 | 5.04 |
| 490 | 21.05 | 6.46 |
| 500 | 25.64 | 8.58 |
| 510 | 31.13 | 10.99 |
| 520 | 37.34 | 13.04 |
| 530 | 43.95 | 14.46 |
| 540 | 50.57 | 15.38 |
| 550 | 56.73 | 15.94 |
| 560 | 62.14 | 16.30 |
| 570 | 66.52 | 16.56 |
| 580 | 69.85 | 16.88 |

The results in Table 3 for the Comparative Example of the Rodenstock Colormatic Extra Contrast Orange lens indicate that the maximum passive transmittance in the 460-500 nm range is 25.64 and the minimum passive transmittance in the 500-580 range is 25.64 yielding an passive contrast ratio of 1.00; and the maximum activated transmittance in the 460-500 nm range is 8.58 and the minimum activated transmittance in the 500-580 range is 8.58 yielding an activated contrast ratio of 1.00.

### Part 4

### Luminance Testing

To provide a real-life example of this improved contrast ratio of the activated state of the lens, the luminance reflected from a white golf ball on a grass-like surface was measured with no intervening filter, and again with the lenses prepared using compositions of Example 1 and Example 2 between the detector and the golf ball on a grass-like surface. (The grass-like surface was a 6 foot by 8 foot outdoor synthetic grass carpet.) The luminance was measured with a Model Li-1800 spectroradiometer at each of the individual wavelengths over the range from 300 to 700 nm and was reported for 10 nm increments. With the sun positioned at 1 o-clock in the sky behind the detector that was at a 45° angle to the plane on which the ball was placed, the reflected luminance from the ball was measured 1 inch from the probe so that only the white from the ball was included in the measured spectra reflected luminance. In a similar manner, the luminance from the grass rug was measured 1 inch from the probe. Finally, the ball upon the grass rug was measured at a distance of 1 foot away so that the measured reflective luminance represented a combination of both the ball and the grass.

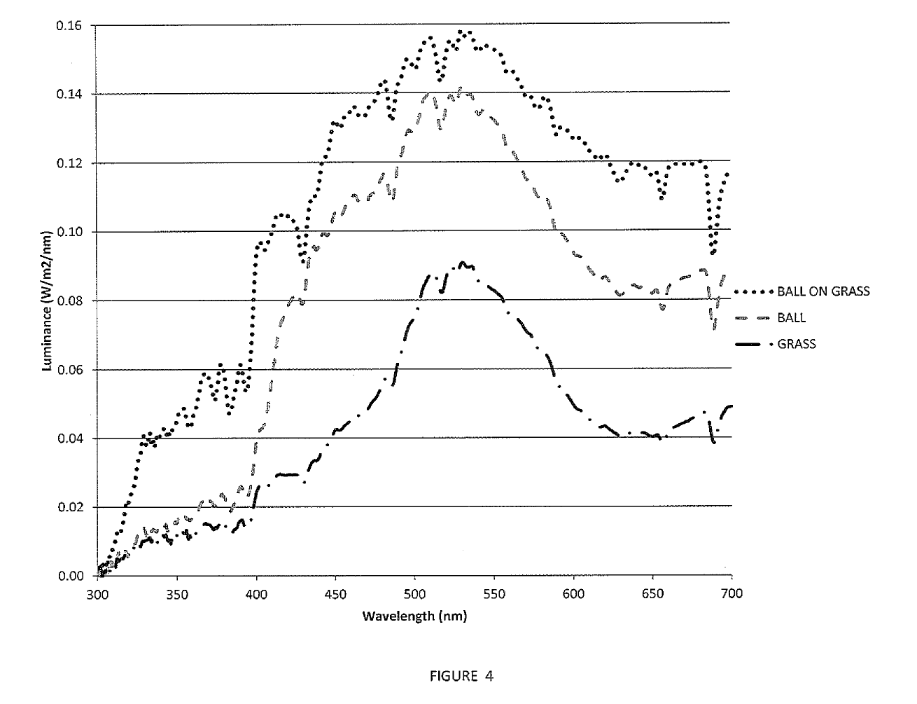

The reflected luminances shown in FIG. 4 represent the reflected solar intensity from the surface of the golf ball alone, the artificial grass alone, and from a broader area encompassing both the golf ball and the artificial grass rug; and demonstrate the extra spectral luminance in the 460 to 500 nm range for the white golf ball compared with the grass alone.

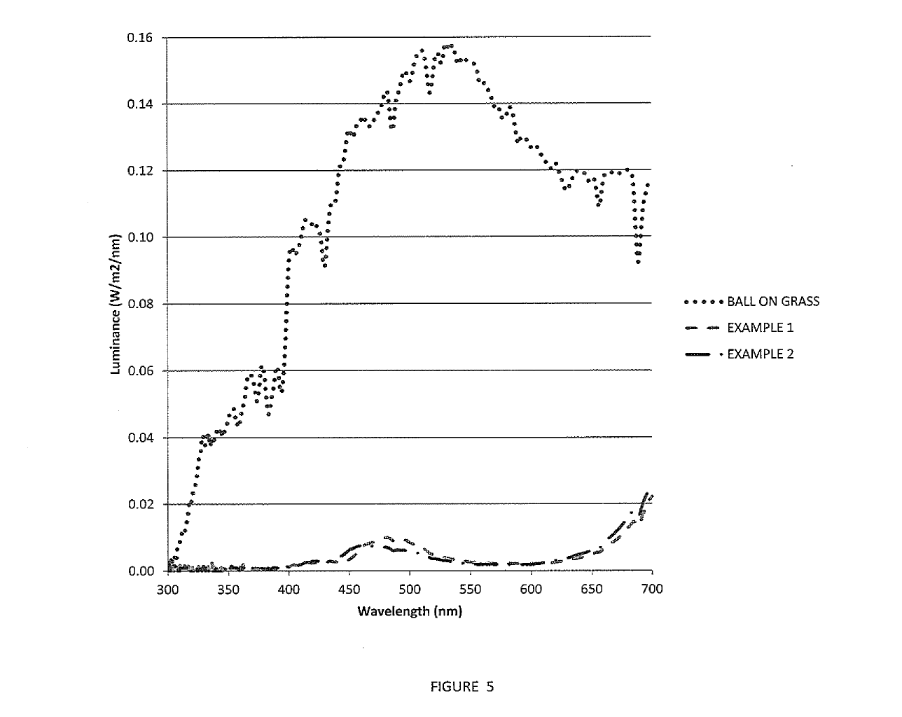

FIG. 5 shows the actual reflected luminance of the broader area encompassing both the golf ball and the grass rug as measured from 1 foot away. This luminance measurement was repeated with a lens from Example 2 in front of the probe. Under the solar and temperature conditions for a sunny day at 35° F., the lens demonstrated 10% transmittance. This luminance measurement was repeated once with a lens of Example 1 in front of the probe. Measurements were obtained under the solar and temperature conditions for a sunny day at 35° F., and the lens demonstrated 8% transmittance.

Luminance measurements show that the difference in the spectra of the white golf ball as compared with the grass is most apparent in the higher relative luminance in the 460 to 500 nm region. This contrast change is readily visible in the change in the ratio of the maximum luminance in the 460 to 500 nm range to the minimum luminance in the 500 to 580 nm range.

TABLE 4
Outdoor reflected luminance (W/m2/nm) of golf ball on grass
mat for no filter, Example 1 filter and Example 2 filter

| Wavelength | No Filter luminance | Example 1 filter | Example 2 filter |
|---|---|---|---|
| (nm) | of ball and grass | of ball and grass | of ball and grass |
| 460 | 0.1345 | 0.0069 | 0.0077 |
| 470 | 0.1336 | 0.0086 | 0.0074 |
| 480 | 0.1430 | 0.0099 | 0.0071 |
| 490 | 0.1421 | 0.0095 | 0.0063 |
| 500 | 0.1476 | 0.0085 | 0.0057 |
| 510 | 0.1559 | 0.0069 | 0.0049 |
| 520 | 0.1493 | 0.0049 | 0.0036 |
| 530 | 0.1579 | 0.0039 | 0.0030 |
| 540 | 0.1524 | 0.0030 | 0.0023 |
| 550 | 0.1527 | 0.0026 | 0.0021 |
| 560 | 0.1457 | 0.0023 | 0.0019 |
| 570 | 0.1395 | 0.0021 | 0.0019 |
| 580 | 0.1360 | 0.0021 | 0.0019 |

The result in Table 4 show that the maximum reflected luminance from the golf ball on the grass mat with no filter was 0.1476 W/m2/nm at 500 nm. The minimum reflected luminance was 0.1360 W/m2/nm at 580 nm yielding a contrast ratio of 1.08. When this same measurement was made, using the lens prepared using the composition of Example 1 in front of the detector, the maximum reflected luminance in the 460-500 nm range was 0.0099 and the minimum luminance in the 500-580 range was 0.0021 yielding a contrast ratio of 4.71. When using the lens prepared using the composition of Example 2 in front of the detector, the maximum activated luminance in the 460-500 nm range was 0.0077 and the minimum activated luminance in the 500-580 range was 0.0019 yielding an activated contrast ratio of 4.05.

Although the present invention has been described with reference to specific details of certain embodiments thereof, it is not intended that such details should be regarded as limitations upon the scope of the invention except insofar as they are included in the accompanying claims.

Therefore, we claim:

1. An optical article comprising:
(A) a substrate; and
(B) a colorant composition connected to at least a portion of the substrate, the colorant composition comprising:
(1) a fixed-tint colorant; and
(2) a photochromic material,
wherein the article exhibits a passive state and an activated state, such that the article can switch from the passive state to the activated state in response to at least actinic radiation and to revert back to the passive state in response to thermal energy, and wherein the passive state is characterized by a transmittance ranging from greater than 30% to 70% across a wavelength range of from 460 nanometers to 500 nanometers.

2. The optical article of claim 1, wherein in the passive state the spectral filtration ratio of the maximum transmittance in the wavelength range of from 460 nm to 500 nm to the minimum transmittance in the wavelength range from 500 nm to 580 nm ranges from 0.5 to 1.5.

3. The optical article of claim 1, wherein in the passive state the spectral filtration ratio of the maximum transmittance in the wavelength range of from 460 nm to 500 nm to the minimum transmittance in the wavelength range from 500 nm to 580 nm ranges from 1.0 to 1.5

4. The optical article of claim 1, wherein in the activated state the spectral filtration ratio of the maximum transmittance in the wavelength range from 460 nm to 500 nm to the minimum transmittance in the wavelength range from 500 nm to 580 nm is equal to or greater than 1.0.

5. The optical article of claim 1, wherein in the activated state the spectral filtration ratio of the maximum transmittance in the wavelength range from 460 nm to 500 nm to the minimum transmittance in the wavelength range from 500 nm to 580 nm is greater than 3.0.

6. The optical article of claim 1, wherein the passive state is characterized by a transmittance ranging from 35% to 70% across a wavelength range of from 460 nm to 500 nm.

7. The optical article of claim 1, wherein the substrate comprises polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, copolymers thereof, and/or mixtures thereof.

8. The optical article of claim 1, wherein the fixed-tint colorant comprises an organic dye chosen from azo dyes, polymethyne dyes, arylmethyne dyes, polyene dyes, anthracinedione dyes, pyrazolone dyes, anthraquinone dyes, quinophtalone dyes and/or carbonyl dyes.

9. The optical article of claim 1, wherein the photochromic material comprises naphthopyrans, benzopyrans, indenonaphthopyrans, phenanthropyrans, spiropyrans, oxazines, mercury dithizonates, fulgides, and/or fulgimides.

10. The optical article of claim 1, wherein the article is chosen from ophthalmic elements and devices, display elements and devices, windows, mirrors, and active and passive liquid crystal cell elements and devices.

11. The optical article of claim 1, further comprising a polarizer chosen from a polarizing coating and/or a polarizing stretched film.

12. The optical article of claim 1, wherein the colorant composition (B) comprises a coating composition comprising at least one of the fixed-tint colorant (1) and the photochromic material (2).

13. The optical article of claim 1, wherein the fixed-tint colorant (1) is present in and/or on the substrate (A), and the photochromic material (2) comprises a coating composition and/or a film connected to the substrate.

14. The optical article of claim 1, wherein the photochromic material (2) is present in and/or on the substrate (A), and the fixed-tint colorant (2) comprises a coating composition and/or a film connected to the substrate.

15. The optical article of claim 1, further comprising one or more additional coatings and/or films comprising primer coatings, compatiblizing coatings, transitional coatings, abrasion-resistant coatings, UV-shielding coatings, oxygen barrier coatings, anti-reflective coatings, mirror coatings, photochromic coating, films comprising any of the foregoing coatings, polarizing coatings, polarizing films; and combinations thereof.
